(19) United States
(12) Patent Application Publication
(10) Pub. No.: US 2009/0086155 A1
(43) Pub. Date: Apr. 2, 2009

(54) Printed glasses

(76) Inventor: Donald Eugene Hodgson, Erie, CO (US)

Correspondence Address: Donald Eugene Hodgson, 400 Young Ct., Erie, CO, 80516, US

(21) Appl. No.: 11/904,591

(22) Filed: Sep. 28, 2007

(51) Int. Cl. G02C 11/00

(52) U.S. Cl. 351/51

(57) ABSTRACT

A pair of glasses where some form of artwork printed on the lens or lenses with a transparent ink. For advertising a person or place or object of personal choice.

### FIELD OF THE INVENTION

This invention is directed to sun glasses or eye glasses for the protection from small objects, weather or sun.

### BACKGROUND OF THE INVENTION

There has been no suggestion in prior art to customize glasses.

### BRIEF SUMMARY OF THE INVENTION

This invention relates to glasses wherein an illustration, photo, or any other form of art or graphics is printed onto the lens or lenses of glasses. The person wearing the glasses will not have their vision effected by this printing. The ink, paint or dye will be transparent.

These and other objects will be more from following more particular description of preferred embodiment illustrated in the accompanying drawing in which reference characters refer to the same parts throughout the various views. The drawing is not necessary to scale. Emphasis instead being upon the principles of the invention.

### BRIEF DESCRIPTION OF THE DRAWINGS

FIG. 1. Front view of the glasses.

### DETAILED DESCRIPTION OF INVENTION

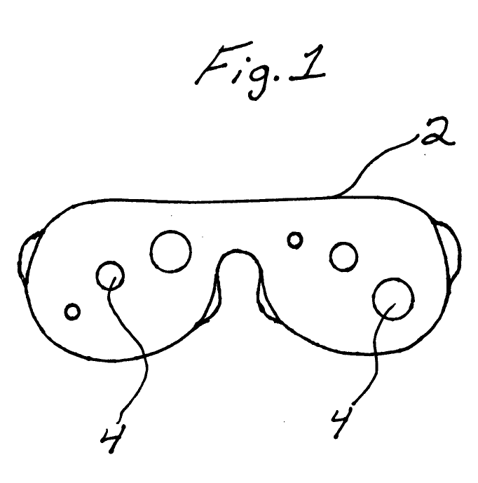

FIG. 1. There is illustrated a pair of glasses (2) with Artwork (4) on the lens.

1 A pair of glasses wherin some form of artwork, graphics, photo or simple lettering is printed directly on the lens or lenses with a water or alcohol based ink, dye so that the artwork can be seen thru and will not effect the vision of the person wearing them.

2 Water or alcohol based inks will be applied to lens or lenses by means of a rubber stamp or by pad printing process.

3 When dyeing lens or lenses a pattern or silhouette made from a flexible material such as silicone rubber is applied to one or both sides of the lens and held in place by means of a clamp. This pattern will not allow another dye or bleach into the pattern area allowing the glasses to have one or more colors. When the pattern is removed a silhouette will be on the lens or lenses.
